(19) United States
(12) Patent Application Publication
(10) Pub. No.: US 2012/0268761 A1
(43) Pub. Date: Oct. 25, 2012

(54) PAPER FEEDING APPRATUS FOR IMAGE FORMING APPARATUS

(75) Inventors: HSIN-HSIEN KUO, Tu-Cheng (TW); KING-LUNG HUANG, Tu-Cheng (TW)

(73) Assignee: HON HAI PRECISION INDUSTRY CO., LTD., Tu-Cheng (TW)

(21) Appl. No.: 13/334,264

(22) Filed: Dec. 22, 2011

(30) Foreign Application Priority Data
Apr. 19, 2011 (TW) 100113477

(51) Int. Cl. G06K 15/02

(52) U.S. Cl. 358/1.13

(57) ABSTRACT

A paper feeding apparatus for an image forming apparatus and a method of the same are disclosed. The paper feeding apparatus for an image forming apparatus, the paper feeding apparatus comprises a paper pick-up unit adapted to pick up a paper sheet from a paper stack in a paper cassette; a paper transfer unit adapted to transfer the paper sheet in a paper transfer path; an image sensor adapted to detect whether there is an image on a first side of the paper sheet, the first side facing the image sensor when the paper sheet is transferred in the paper transfer path; and a paper reverse unit adapted to reverse the paper sheet through a paper reverse path when the image sensor detects an image on the first side of the paper sheet.

### BACKGROUND

1. Technical Field

The disclosure generally relates to an image forming apparatus, and particularly relates to a paper feeding apparatus for an image forming apparatus.

2. Description of Related Art

An image forming apparatus can perform printing on a side of a paper sheet. If one side of a paper sheet has been printed or has an image residing on it and a user intends to print the other side of the paper sheet, a problem may arise since it may be quite difficult for the user to determine which side of the paper sheet should be faced upwards when it is put into a paper cassette of the image forming apparatus. The user may find that the wrong side has been printed. It is a bad experience for the user and may cause a waste of paper. Therefore, there is a need for a technique for enabling the image forming apparatus to automatically determine and select a blank side of a paper sheet.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a sectional view showing an image forming apparatus according to one embodiment.

FIG. 2 is a flowchart showing one embodiment of a method for feeding in a paper sheet using the image forming apparatus of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

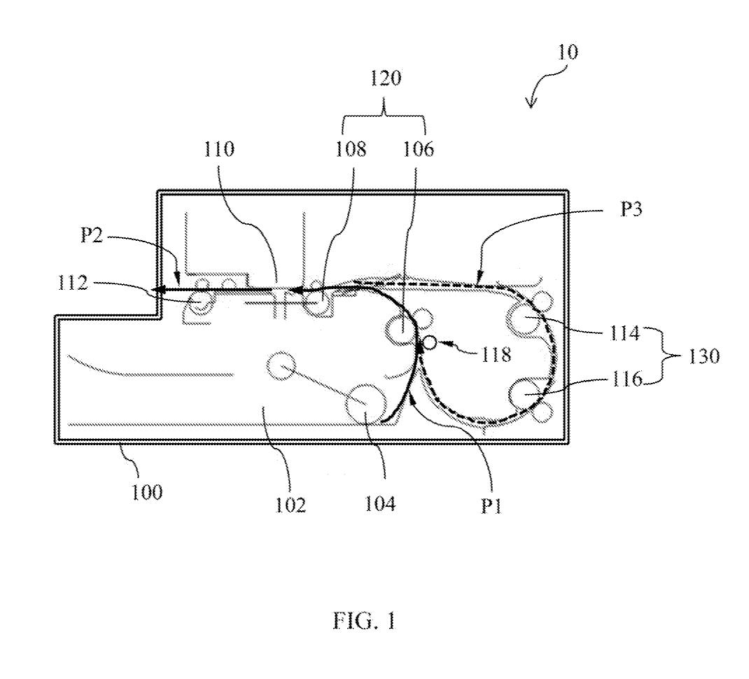

FIG. 1 shows an image forming apparatus 10 according to one embodiment. The image forming apparatus 10 comprises a main body 100 forming the housing of the image forming apparatus 10, a paper cassette 102 mounted on the bottom of the main body 100, a pick-up roller 104 for picking up a paper sheet from a paper stack of the paper cassette 102, a paper transfer unit 120 including a delivering roller 106 for delivering the paper sheet picked up by the pick-up roller 104 and a feeding roller 108 for feeding the paper sheet delivered by the delivering roller 106, an image forming section 110 for forming an image on the paper sheet fed by the feeding roller 108, and a discharge roller 112 for discharging the paper sheet.

A paper transfer path P1 is formed between the pick-up roller 104 and the image forming section 110 to guide a route of transferring a paper sheet from the paper cassette 102 to the image forming section 110. The discharge roller 112 is installed at the outlet of a paper discharge path P2, through which a paper sheet can be discharged. One end of the paper discharge path P2 is connected to the image forming section 110 and the other end of the paper discharge path P2 extends out of the main body 100.

The image forming apparatus 10 further comprises a paper reverse unit 130, which comprises two reverse rollers 114 and two reverse rollers 116, for reversing a paper sheet when the paper sheet needs to be reversed. The paper reverse unit 130 can reverse a paper sheet by transferring the paper sheet though a paper reverse path P3. The paper reverse path P3 is laterally branched from the paper transfer path P1 just before the feeding roller 108 (also before the image forming section 110) and extends away from the feeding roller 108 (also away from the image forming section 110). One end of the paper reverse path P3 is connected to the feeding roller 108 and the other end of the paper reverse path P3 is connected to the delivering roller 106. When a paper sheet has passed through the paper reverse path P3, the delivering roller 106 may put the paper sheet back into the paper transfer path P1.

The image forming apparatus 10 further comprises an image sensor 118 for detecting whether an image resides on a side of a paper sheet, which is currently faced to the image sensor 118. The image sensor 118 is arranged in the paper transfer path P1. While a paper sheet is being routed into the paper transfer path P1 and is passing in front of the image sensor 118, the image sensor 118 may detect whether an image resides on the facing side.

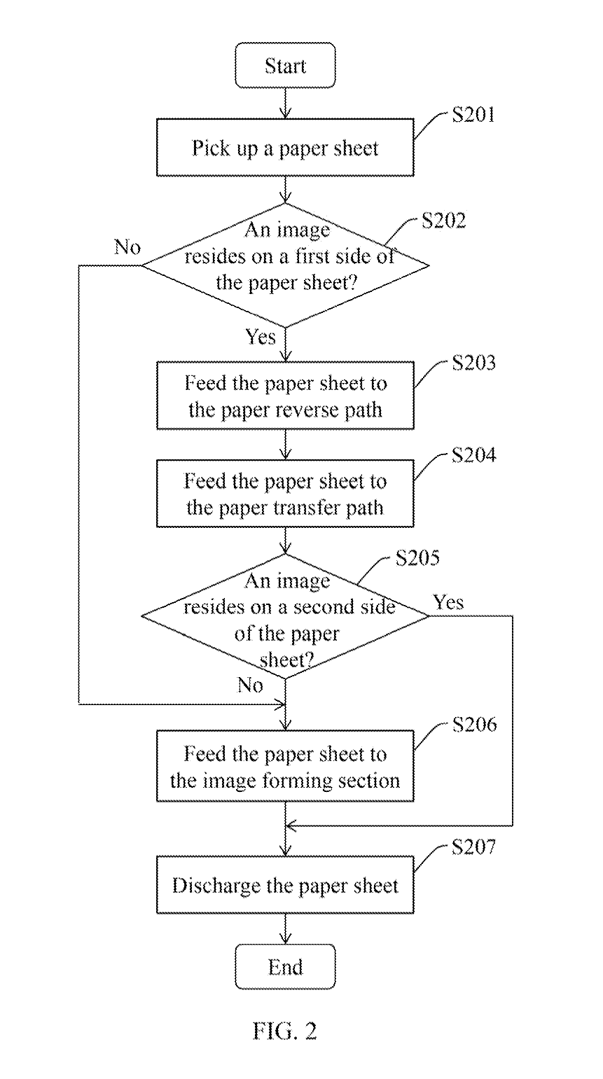

FIG. 2 is a flowchart showing one embodiment of a method for feeding a paper sheet using the image forming apparatus 10 of FIG. 1. The method may comprise the following steps.

In step S201, the pick-up roller 104 picks up a paper sheet from a paper stack in the paper cassette 102 and sends the paper sheet to the paper transfer path P1, where the paper sheet is carried by the pick-up roller 104, the delivering roller 106 and the feeding roller 108.

In step S202, the image sensor 118 detects whether an image resides on a first side of the paper sheet, which is currently faced to the image sensor 118, when the paper sheet is passing in front of the image sensor 118 in the paper transfer path P1. If there is an image residing on the first side of the paper sheet, the flow goes to step S203. If there is no image residing on the first side of the paper sheet, the flow goes to step S206.

In step S203, the feeding roller 108 and the discharge roller 112 reverse rotation before the tail edge of the paper sheet has travelled through and feed the paper sheet into the paper reverse path P3, through which the paper sheet is carried by the reverse rollers 114 and 116. Then the flow goes to step S204.

In step S204, when the paper sheet has passed through the paper reverse path P3, the delivering roller 106 feeds the paper sheet into the paper transfer path P1.

In step S205, the image sensor 118 detects whether an image resides on a second side of the paper sheet, which is currently faced to the image sensor 118, when the paper sheet is again passing in front of the image sensor 118 in the paper transfer path P1. If there is no image residing on the second side of the paper sheet, the flow goes to step S206. If there is an image residing on the second side of the paper sheet, the flow goes to step S207.

In step S206, the feeding roller 108 feeds the paper sheet to the image forming section 110 for forming an image on the side of the paper sheet, which is faced to the image forming section 110.

In step S207, the paper sheet is put into the paper discharge path P2, through which the discharge roller 112 discharges and ejects the paper sheet of the main body 100.

Although numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

Depending on the embodiment, certain steps or methods described may be removed, others may be added, and the sequence of steps may be altered. The description and the claims drawn for or in relation to a method may comprise some indication in reference to certain steps. However, any indication used is only to be viewed for identification purposes and not as a suggestion as to an order for the steps.

What is claimed is:

1. A paper feeding apparatus for an image forming apparatus, the paper feeding apparatus comprising:
a paper pick-up unit adapted to pick up a paper sheet from a paper stack in a paper cassette;
a paper transfer unit adapted to transfer the paper sheet in a paper transfer path;
an image sensor adapted to detect whether there is an image on a first side of the paper sheet, the first side facing the image sensor when the paper sheet is transferred in the paper transfer path; and
a paper reverse unit adapted to reverse the paper sheet through a paper reverse path when the image sensor detects an image on the first side of the paper sheet.

2. The paper feeding apparatus of claim 1, wherein the paper transfer unit is further adapted to transfer the paper sheet to an image forming section of the image forming apparatus for forming an image on the first side of the paper sheet when the image sensor detects no image on the first side of the paper sheet.

3. The paper feeding apparatus of claim 2, wherein one end of the paper transfer path is connected with the paper pick-up unit and another end of the paper transfer path is connected with the image forming section.

4. The paper feeding apparatus of claim 3, wherein the paper reverse path is laterally branched from the paper transfer path before the image forming section and extends away from the image forming section.

5. The paper feeding apparatus of claim 4, wherein the paper reverse unit is further adapted to transfer the paper sheet to the paper transfer path when the paper sheet has passed through the paper reverse path.

6. The paper feeding apparatus of claim 5, wherein the image sensor is further adapted to detect whether there is an image on a second side of the paper sheet, the second side is opposite to the first side and facing the image sensor when the paper sheet is transferred to the paper transfer path from the paper reverse path.

7. The paper feeding apparatus of claim 6, further comprising a paper discharge unit adapted to discharge the paper sheet when the image sensor detects an image on the second side of the paper sheet.

8. The paper feeding apparatus of claim 6, wherein the paper transfer unit is further adapted to transfer the paper sheet to the image forming section for forming an image on the second side of the paper sheet when the image sensor detects no image on the second side of the paper sheet.

9. An image forming apparatus comprising:
a main body comprising an image forming section, the image forming section is adapted to form an image;
a paper pick-up unit adapted to pick up a paper sheet from a paper stack in a paper cassette;
a paper transfer path in the main body, the paper transfer path is a route of transferring the paper sheet from the paper pick-up unit to the image forming section;
an image sensor adapted to detect whether there is an image on a first side of the paper sheet, the first side facing the image sensor when the paper sheet is transferred in the paper transfer path; and
a paper reverse path within the main body, the paper transfer path is a route of reversing the paper sheet when the image sensor detects an image on the first side of the paper sheet.

10. The image forming apparatus of claim 9, wherein one end of the paper transfer path is connected with the paper pick-up unit and another end of the paper transfer path is connected with the image forming section.

11. The image forming apparatus of claim 10, wherein the paper reverse path is laterally branched from the paper transfer path before the image forming section and extends away from the image forming section.

12. The image forming apparatus of claim 11, wherein the paper transfer path is further adapted to receive the paper sheet when the paper sheet has passed through the paper reverse path.

13. The image forming apparatus of claim 12, wherein the image sensor is further adapted to detect whether there is an image a second side of the paper sheet, the second side is opposite to the first side and facing the image sensor when the paper sheet is transferred in the paper transfer path from the paper reverse path.

14. The image forming apparatus of claim 13, further comprising a paper discharge path, the paper discharge path is a route of discharging the paper sheet when the image sensor detects an image on the second side of the paper sheet.

15. A paper feeding method in an image forming apparatus, the paper feeding method comprising:
picking up a paper sheet from a paper stack in a paper cassette by a paper pick-up unit;
providing an image forming section and an image sensor;
providing a paper transfer path between the paper pick-up unit and the image forming section;
providing a paper reverse path of reversing the paper sheet;
transferring the paper sheet in the paper transfer path with a first side of the paper sheet facing the image sensor;
detecting b whether an image is on the first side of the paper sheet; and
reversing the paper sheet through the paper reverse path when the image sensor detects an image on the first side of the paper sheet.

16. The paper feeding method of claim 15, further comprising feeding the paper sheet to the image forming section and forming an image on the first side of the paper sheet when the image sensor detects no image on the first side of the paper sheet.

17. The paper feeding method of claim 15, further comprising sending the paper sheet to the paper transfer path when the paper sheet has passed through the paper reverse path.

18. The paper feeding method of claim 17, further comprising facing a second side, opposite to the first side, of the paper sheet to the image sensor when the paper sheet is transferred from the paper reverse path to the paper transfer path; and detecting by the image sensor whether there is an image on a second side of the paper sheet.

19. The paper feeding method of claim 18, further comprising feeding the paper sheet to the image forming section and forming an image on the second side of the paper sheet when the image sensor detects no image residing on the second side of the paper sheet.

20. The paper feeding method of claim 18, further comprising discharging the paper sheet upon a condition that the image sensor detects an image residing on the second side of the paper sheet.
